(19) United States
(12) Patent Application Publication
(10) Pub. No.: US 2026/0330487 A1
(43) Pub. Date: Oct. 22, 2026

(54) APPARATUS FOR SAMPLE SIZE PLANNING

(71) Applicant: Minitab, LLC, State College, PA (US)

(72) Inventors: Senin J. Banga, State College, PA (US); Cheryl L. Pammer, San Diego, CA (US)

(73) Assignee: Minitab, LLC, State College, PA (US)

(21) Appl. No.: 19/183,140

(22) Filed: Apr. 18, 2025

(51) Int. Cl. G06Q 30/0202

(52) U.S. Cl. CPC G06Q 30/0202

(57) ABSTRACT

An apparatus for sample size planning includes a controller configured to generate information about a sample size of units required to achieve a predetermined predictive accuracy criterion based at least on a number of predictors and a squared correlation value.

### TECHNICAL FIELD

The present disclosure generally relates to an apparatus for sample size planning and evaluation mechanisms and more particularly to systems and methods for determining sample size required (or needed) for controlling the predictive performance of linear regression models.

### BACKGROUND

In many industries, determining the quality characteristics or properties of products such as tensile strength, purity, or concentration and the factors or predictors influencing the quality characteristics is critical before selling or marketing the products. Accurate evaluation of the properties helps the product to meet desired quality standards and performs as intended. To evaluate the properties, a random sample of the products are collected, tested and the test results are summarized in a regression sample where the quality characteristic of interest is the response variable and the relevant factors influencing the quality characteristic are the predictors. The resulting regression data is used to build a predictive regression model that relates the quality characteristic of the product to the relevant predictors. The predictive performance of the regression model, however, can depend on the sample size, the given number of predictors, and the strength of the linear relationship between the quality characteristic of interest and the predictors. Testing and evaluating too few products can lead to unreliable predictions, whereas testing and evaluating too many products may unnecessarily increase the evaluation costs and cause wastage of resources.

### SUMMARY

According to an embodiment of the present disclosure, an apparatus for sample size planning for predictive modeling includes at least one sensor and a controller operatively connected to the sensor. The controller includes a processor and a memory with one or more computer program instructions stored in the memory, which when executed by the processor, cause the controller to receive a squared correlation value (ρ²), indicative of the strength of linear relationship between the quality characteristic, which is a response or output variable, of the material or product and a set of predictors or input variables influencing the quality characteristic, the number of predictors in the regression model and a predetermined predictive accuracy criterion for the regression model relating the quality characteristic to the predictors. The apparatus determines the regression sample size (n) required to achieve the predetermined predictive accuracy criterion or predictive accuracy level. The apparatus gathers the regression sample with the calculated required size (n) by sequentially applying stimulus to each of randomly selected sample units and measuring the quality characteristic values or response values corresponding to predictor values or settings with the sensor. The apparatus automatically stops applying stimulus and gathering more sample units when the number of units evaluated has reached the calculated required sample size (n). Further, the regression data including the response data and predictor data collected from the apparatus can be used to generate the regression model.

In an embodiment, the temperature and the speed at which a unit such as a packaged-good flows through a machine are the factors influencing the tensile strength measurements. Thus, for each randomly selected unit one or more sensors record the temperature, assesses the speed and then measures the corresponding tensile strength value. In the end, the regression sample comprises tensile strength values (response values) and corresponding temperature and speed values (predictors). In other embodiments, other factors such as environmental factors including for example temperature, humidity, and atmospheric pressure may be measured for use as predictors.

In an embodiment, the apparatus is a specialized tensile strength testing apparatus configured with a load frame, a gripping mechanism, and a movable platform adapted to apply mechanical stress as the stimulus to a sample unit. The apparatus may also include one or more physical modules such as a touchscreen, an input device adapted to receive or measure input data, or otherwise any module configured to perform one or more methods described herein.

According to one or more embodiments of the present disclosure, methods and systems for determining the sample size required (or needed) to control the predictive performance of regression models are disclosed. The methods include receiving a squared correlation value (ρ²), indicative of the strength of a linear relationship between a quality characteristic of a product or material and relevant predictors influencing the quality characteristic, the number of predictors in the regression model, and a predetermined predictive accuracy criterion set to control the predictive performance of the regression model. The methods further determine a sample size (n) required to achieve the predetermined predictive accuracy criterion based on a number of predictors in the regression model and the squared correlation value. The methods further include collecting a regression sample with the calculated sample size (n) for evaluation and sequentially applying stimulus to each of randomly selected sample units (e.g. products or materials) to gather response data and corresponding predictor data using at least one sensor. The methods further include automatically terminating the evaluation and data collection when the number of sample units reaches the calculated required sample size (n). Finally, the methods use the collected data to generate the regression model.

In one embodiment, each of the methods may also include receiving the squared correlation value (ρ²), the number of predictors (ρ) in the regression model and the predetermined predictive accuracy criterion through a user interface. The squared correlation value (ρ²), also known as the planning value of the squared correlation parameter, is obtained from one or more expert opinions or from prior studies involving similar regression models. In situations, where such a planning value is unavailable, a pilot or small study may be conducted for the sole purpose of estimating the square correlation to be used as the planning value in a main study.

In an embodiment the apparatus applies mechanical stress to sample units to measure the corresponding response data, and the apparatus is a tensile strength testing machine.

According to another embodiment of the present disclosure, a non-transitory computer readable storage medium stores computer-readable instruction that when executed by a processor of an apparatus cause the apparatus to: receive a squared correlation value (ρ²), indicative of the strength of linear relationship between the quality characteristic of the material or product, which is the response or output variable, and a set of predictors or input variables influencing the quality characteristic, the number of predictors in the regression model and a predetermined predictive accuracy criterion for the regression model relating the quality characteristic to the predictors. The apparatus determines the regression sample size (n) required to achieve the predetermined predictive accuracy criterion or predictive accuracy level. The apparatus gathers the regression sample with the calculated required size (n) by sequentially applying stimulus to each of the randomly selected sample units and measuring the quality characteristic values or response values corresponding to predictors values or settings with the sensor. The apparatus automatically stops applying stimulus and gathering more sample units when the number of units evaluated has reached the calculated required sample size (n). Further, the regression data including the response data and predictor data collected from the apparatus can be used to generate the regression model.

Aspects described below include a non-transitory computer-readable storage medium comprising computer-executable instructions that, responsive to execution by a processor, cause a system to perform any one of the described methods.

Aspects described below also include a system with means for determining sample size for controlling the predictive performance of regression models.

### BRIEF DESCRIPTION OF THE DRAWINGS

Apparatuses and techniques for determining sample size needed to control the predictive performance of regression models are described with reference to the following drawings. The same numbers are used throughout the drawings to reference like features and components. The drawings are of illustrative embodiments, they do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts a block diagram of a data processing environment in which illustrative embodiments may be implemented.

FIG. 2 depicts a block diagram of a data processing system in which illustrative embodiments may be implemented.

FIG. 3 depicts a flowchart of an example method for determining sample size required (or needed) to control the predictive performance of regression models, in accordance with an illustrative embodiment.

FIG. 4 depicts a block diagram of an apparatus for determining sample size required to control the predictive performance of regression models, in accordance with an illustrative embodiment.

FIG. 5 depicts a flowchart of a process for evaluating tensile strength of sample units using a tensile strength testing apparatus, in accordance with an exemplary embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high level, without detail, to avoid unnecessarily obscuring aspects of the present teachings.

Evaluation of physical or chemical characteristics of final products or material used in the final products are performed in various industries to maintain consistent product quality and to ensure compliance to specific industry standards and regulatory parameters. For example, industries such as manufacturing, pharmaceutical, chemical etc., regularly perform evaluation on randomly selected samples of their final produced products to ensure reliability or quality of the products. Typically, evaluation of a sample unit of the products includes measuring quality characteristics such as tensile strength, elasticity, chemical composition, or other physical or chemical characteristics and how different variables affect the measured quality characteristics of the sampled products. The variables that affect a particular characteristic of interests, e.g., tensile strength may be used as predictors in the building of a predictive regression model that relates the characteristic of interest, i.e. the response variable, to the predictors.

It is recognized that methods for generating the predictive model may use a large number of sample units or products for evaluation or testing. Furthermore, certain existing methods may yield excessive sample size parameters or may be based on criteria that are not easy to interpret practically. Consequently, the predictive regression model thus generated using the existing methods may result in inefficient usage of resources, prolonged evaluation timelines, and increased operational costs. Furthermore, traditional methods for determining the sample size often provide complex results which are difficult to interpret without specialized training.

Techniques are described that plan sample size for predictive modeling. One or more embodiments disclosed herein facilitate estimating a required sample size or a minimum number of sample units by clearly defining the quality characteristics of a product and the predictors influencing the quality characteristics, using an apparatus having at least one sensor and a controller. The method includes receiving inputs, which, in one implementation, includes a squared correlation value (ρ²) indicative of a relationship between a quality characteristic of a product or material and one or more predictors influencing the quality characteristics, the number of predictors (ρ) in the model, and a predetermined predictive accuracy criterion set to control predictive performance of a regression model relating the quality characteristic with the one or more predictors. The controller is configured to determine the sample size (n) required to achieve the predetermined predictive accuracy level based on the number of predictors (ρ) in the regression model and the squared correlation value. In one embodiment, the squared correlation value (ρ²), the number of predictors (ρ) in the regression model, and the predetermined predictive accuracy criterion are received by the controller through a user interface. The squared correlation value (ρ²), also called planning value of the squared correlation, is obtained from one or more expert opinions or from prior studies involving similar models. In some instances where such a planning value is unavailable a pilot or small study may be conducted for the sole purpose of estimating the square correlation value to be used as the planning value in a main study. A regression sample with the determined sample size (n) is collected by sequentially applying a stimulus to each of the randomly selected sample units and measuring the quality characteristic values or response values corresponding to predictors values or settings using at least one sensor. The controller is configured to automatically terminate the evaluation and data collection when the number of evaluated sample units reaches the determined sample size (n). The data thus gathered can be used to generate the regression model.

Importantly, although the operational and functional descriptions provided here may appear understandable by a human mind, they are not abstract ideas or mental processes or mere data gathering divorced from computational implementation of those operations and functions. Rather, the described operations and functions represent the specification of a specifically configured evaluation or testing apparatus or system including a computing device operatively coupled with various sensors, actuators, automated sample unit handling mechanisms, and controllers. The components physically operate together in a manner integral to the predictive modeling process. In particular, the methods and apparatus described herein automatically determine sample size needed to control the predictive performance of regression models, thereby providing improved computational efficiency, improved accuracy in predictive modeling tasks, while significantly reducing time, cost and energy demands.

Moreover, as described above, the operational and functional language provided here must be interpreted within its appropriate technological context. Specifically, the claimed methods, apparatus, and systems address practical technological problems encountered in predictive modeling and physical evaluation scenarios by reducing inefficiencies and resource wastage due to inadequate or excessive sample size selections in physical testing or evaluation environments.

Accordingly, one or more of the methodologies discussed herein may obviate a need for time-consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user. Moreover, measurements of properties such as physical properties may be performed by dedicated devices or sensors. These measurements may be incapable of being obtained by a human without the use of dedicated devices or sensors.

Furthermore, the operations and functions disclosed here optimize computational and operational resource utilization in the evaluation apparatus. For instance, automatically terminating evaluations when the number of evaluated sample units reaches the determined sample size (n) substantially reduces unnecessary processor cycles, sensor usage, memory storage, network traffic associated with remote computing tasks and power consumption for physically performing the evaluations and data handling tasks. As such, embodiments of the invention achieve tangible improvements in the operation of the testing or evaluation apparatus, resulting in improved computational efficiency, improved accuracy in predictive modeling tasks, and decreased time, cost and energy requirements. The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

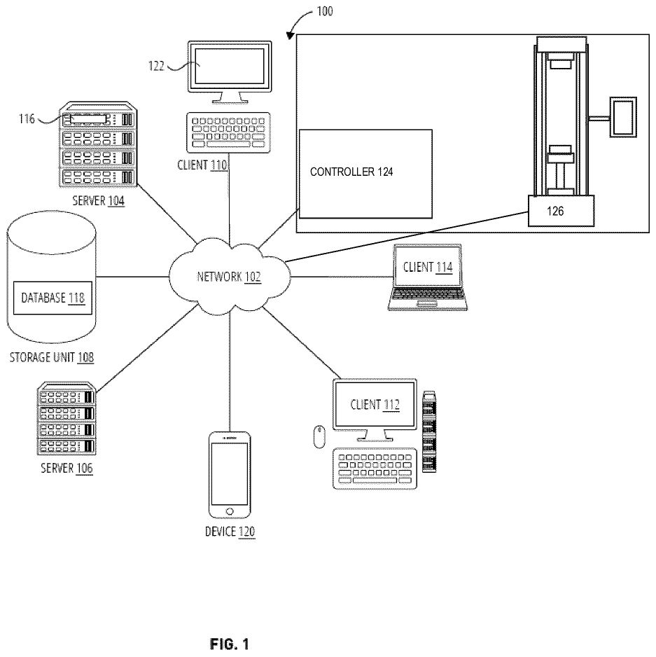

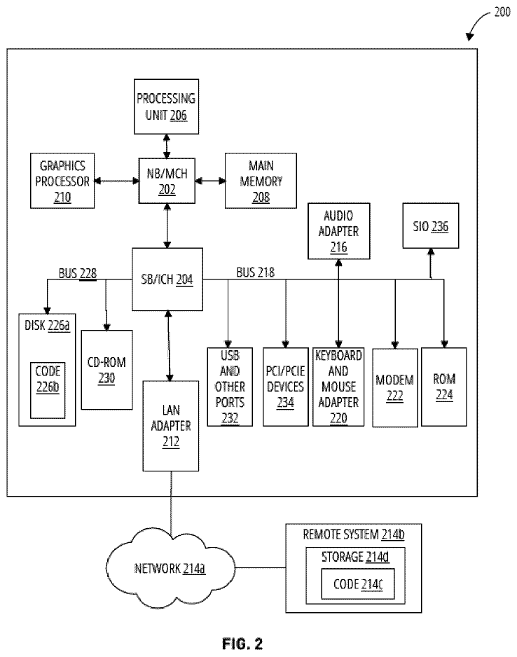

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within the data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, and client 114 are also coupled to network 102. A data processing system, such as server 104 or server 106, or clients (client 110, client 112, client 114) may contain data and may have software applications or software tools executing thereon. Server 104 may include one or more GPUs (graphics processing units) for training one or more models.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Device 120 is an example of a device described herein. For example, device 120 can take the form of a smartphone, a special purpose fabrication platform, a tablet computer, a laptop computer, client 110 in a stationary or a portable form, a wearable computing device, or any other suitable device. Any software application described as executing in another data processing system in FIG. 1 can be configured to execute in device 120 in a similar manner. Any data or information stored or produced in another data processing system in FIG. 1 can be configured to be stored or produced in device 120 in a similar manner.

A controller 124 may execute as part of client application 122, server application 116, or may form or be a part of any data processing system herein such as the tensile strength apparatus 126. The controller 124 may also execute as a cloud service communicatively coupled to system services, hardware resources, or software elements described herein. Database 118 of storage unit 108 stores one or more data in repositories for computations herein. The controller 124 may perform a method comprising: receiving input including a squared correlation value (ρ²), indicative of the strength of linear relationship between the quality characteristic of interest of the material or product and a set of predictors or input variables influencing the quality characteristic, the number of predictors in the regression model and a predetermined predictive accuracy criterion for the regression model relating the quality characteristic to the predictors. The controller 124 is configured to estimate an optimal sample size (n) to be evaluated based on the square correlation value, the number of predictors in the model, and the predetermined predictive accuracy criterion. Once the value of ‘n’ is evaluated based on the number of predictors in the model, a planning value for square correlation (a value that may be based on expert opinions, a prior similar study or a pilot study), an operator through a user interface of the controller 124 initiates the sequential evaluation or testing of the sample units. The operator evaluates each of the sample units among the calculated sample size (n) by sequentially applying a stimulus to each of the randomly selected sample units and measuring the quality characteristic values or response values corresponding to predictors values or settings with a sensor and terminating the evaluation automatically when the number of units evaluated has reached the calculated sample size (n). The method is further configured to generate a predictive model from the regression data including the response data and predictor data collected from the apparatus.

Server application 116 implements an embodiment described herein. Server application 116 can use data from storage unit 108 for determining an optimal sample size (n) or minimum number of samples required for accurate predictive modeling. Server application 116 can also obtain data from any client for computations. Server application 116 can also execute in any of data processing systems (server 104 or server 106, client 110, client 112, client 114), such as client application 122 in client 110, and need not execute in the same system as server 104.

Server 104, server 106, storage unit 108, client 110, client 112, client 114, and de vice 120 may couple to network 102 using wired connections, wireless communication protocols, or other suitable data connectivity. Client 110, client 112, and client 114 may be, for example, personal computers or network computers.

In the depicted example, server 104 may provide data, such as boot files, operating system images, and applications to client 110, client 112, and client 114. Client 110, client 112, and client 114 may be clients to server 104 in this example. Client 110, client 112, and client 114 or some combination thereof, may include their own data, boot files, operating system images, and applications. Data processing environment 100 may include additional servers, clients, and other devices that are not shown. Server 104 includes a server application 116 that may be configured to implement one or more of the functions described herein in accordance with one or more embodiments.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as server 104, server 106, or client 110, client 112, client 114, controller 124 in FIG. 1, or another type of device in which computer-usable program code or instructions implementing the processes may be located for the illustrative embodiments.

Data processing system 200 is also representative of a data processing system or a configuration therein, such as device 120 in FIG. 1 in which computer-usable program code or instructions implementing the processes of the illustrative embodiments may be located. Data processing system 200 is described as a computer only as an example, without being limited thereto. Implementations in the form of other devices, such as device 120 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read-only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object-oriented or other type of programming system may operate in conjunction with the operating system and provide calls to the operating system from programs or applications executing on data processing system 200.

Instructions for the operating system, the object-oriented programming system, and applications or programs, such as server application 116 and client application 122 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer-implemented instructions, which may be located in a memory, such as, for example, main memory 208, read-only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

### Determining Optimal Sample Sizes for Predictive Modeling

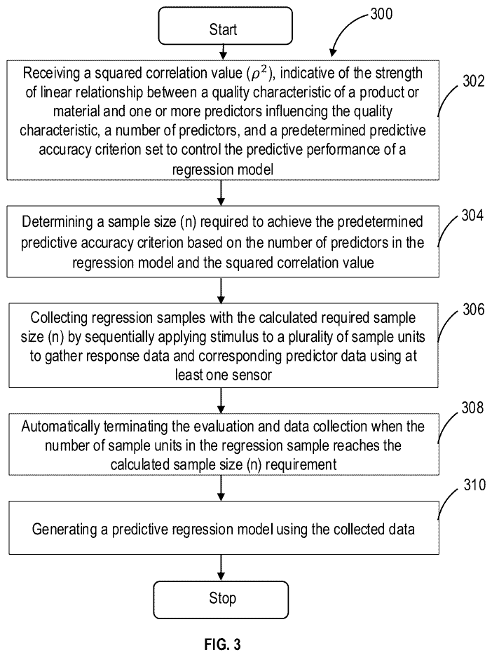

FIG. 3 illustrates an exemplary flowchart 300 describing a method for determining sample size parameters to control predictive performance of regression models and to accurately evaluate a quality characteristic of a product, according to one or more embodiments of the invention. The method shown in flowchart 300 is executed by an apparatus, which includes at least one sensor and a controller. The apparatus can be any machine or system suitable for performing various types of physical or chemical evaluation or testing. Examples of such apparatus may include tensile strength testing machines, chemical analyzers, or other similar testing instruments which may operate similarly to examples provided herein to generate regression samples. In certain embodiments, methods depicted in FIG. 3 are performed automatically by the apparatus utilizing the controller. In other embodiments, some of the blocks in FIG. 3 are performed by an operator of the apparatus.

At block 302, the controller receives a squared correlation value (ρ²) as one of the input parameters. The squared correlation value measures the strength of linear relationship between the quality characteristic such as tensile strength, chemical purity or concentration of the product and one or more predictors influencing the quality characteristic. The controller further receives the number of predictors in the model and a predetermined predictive accuracy criterion, which specifies the desired predictive accuracy level for a regression model used in predicting the quality characteristic of the products based on the one or more predictors given as an input to the controller. Typically, the squared correlation value (ρ²) is given as an input to the controller through a user interface and may be based on historical data, small pilot studies, expert opinions, or previous evaluations.

Next, at block 304, the controller calculates the sample size (n) or minimum number of sample units required to achieve the predetermined predictive accuracy criterion, utilizing the squared correlation value received in the previous block 302. Evaluation or testing of the sample units with the calculated sample size (n) ensures efficient resource usage while achieving the desired accuracy in the predictive or regression model.

Block 306 involves collecting a regression sample with the determined sample size (n) by sequentially applying a stimulus to the sample units and gathering response data and corresponding predictor data using one or more sensors. During the evaluation of testing of the selected sampled units, a predefined stimulus such as force, pressure, temperature or chemical reagent is sequentially applied to each of the selected sample unit. Response data and predictor data corresponding to the applied stimulus is gathered using the sensors associated with the apparatus. In certain embodiments, the evaluation of each of the sample units is a sequential and automated process, which facilitates accurate and consistent data collection, significantly reducing errors caused by a human.

Upon reaching block 308, the evaluation of each of the sample units and the corresponding data collection is automatically terminated when the number of sample units in the regression sample reaches the calculated sample size (n). The automated termination offers advantages such as prevention of unnecessary use of resources beyond the determined sample size (n), thereby providing significant cost reduction and ensures efficient usage of resources and time. At block 310, a regression model is generated using the data collected from each evaluated sample unit.
In an embodiment, the size of a regression sample with a specified number of predictors (ρ) is determined to ensure that the expected proportional loss in predictive precision (PLPP) induced by an estimated regression model when it, rather than the true regression model, is used to make sure predictions does not exceed a prespecified threshold value (ε). In other words, the required size of the regression sample ensures that the estimated regression models based on a similar sample induce, on average, a low PLPP not exceeding the specified threshold value (ε). The calculated sample sizes based on this predictive accuracy criterion are less demanding and yield moderate planned sample sizes. Thus, for applications where moderate predictive precision is sufficient this sample size planning method can be used. The resulting required sample sizes (n) are calculated using the following equation.

$$n = \frac{( p - 1 ) ( 1 - {ρ}^{2 *} ) - ε p}{ε {ρ}^{2 *}} + 2 p + 2 , \qquad Equation A$$

where p represents the number of predictors in the regression model, ρ² the square correlation, and ε the expected PLPP threshold value.

For applications demanding higher precision, such as pharmaceuticals, medical devices, or safety-critical materials, a more rigorous sample size planning method can be used. In this case the size of a regression sample with a specified number of predictors (p) is determined to ensure that the PLPP induced by an estimated regression model when it, rather than the true regression model, is used to make predictions does not exceed a prespecified threshold value (ε) with a high probability (γ). In other words, the size of a regression sample is determined to guarantee that a prespecified high proportion (γ) of the estimated regression models based on a similar sample induce low proportional losses in predictive precision not exceeding the specified threshold value (ε). The required sample size (n) is calculated using the following equation:

$$n = \frac{( 1 - {ρ}^{2 *} ) {λ}_{0}^{2}}{{ρ}^{2 *}} + p + 2 , \qquad Equation B$$

where λ₀ is a numerical solution of the non-linear equation:

1+T_{p-1,λ}(−\sqrt{(ρ−1)(1/ε−1)})−T_{p-1,λ}(\sqrt{(ρ−1)(1/ε−1)})=γ,

where the function T_{p-1,λ}(.) represents the cumulative distribution function (CDF) of the noncentral t-distribution with p−1 degrees of freedom and non-centrality parameter λ.

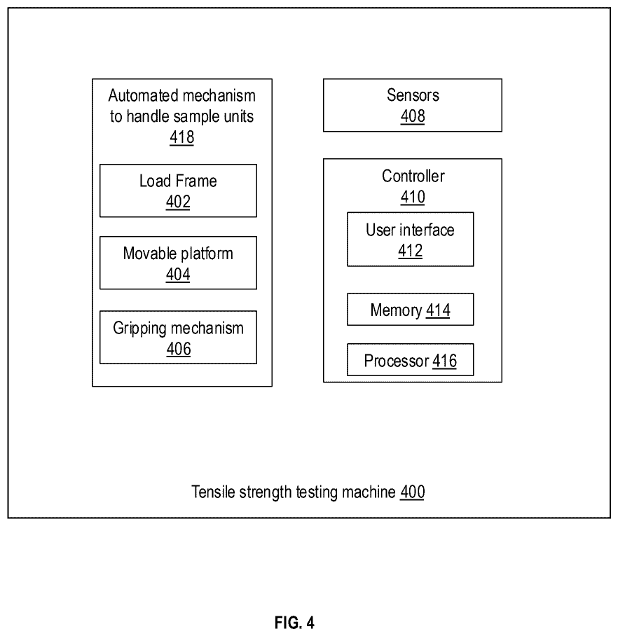

FIG. 4 illustrates a tensile strength testing apparatus 400 as the apparatus for physical characteristic evaluations, according to an exemplary embodiment. The tensile strength testing apparatus 400 is an example of the tensile strength testing apparatus 126 and includes components such as a load frame 402 to house multiple components and provides stability during testing, a movable platform 404 configured to apply a stimulus such as tensile force or compression, a gripping mechanism 406 for securely holding the sample units during testing, and one or more sensors 408 (such as a load cell and/or an extensometer) to measure response values (such as tensile strength) during the testing. A controller 410 manages the operation of the tensile strength testing apparatus 400. The controller 410 typically includes a user interface 412 to receive one or more inputs from an operator and to display information, a memory 414 for storing computer program instructions and a processor 416 to process the instructions. The controller 410 automates the testing process by sequentially loading and unloading the sample units using an automated sample unit handling mechanism 418 and accurately controlling the stimulus and recording response data received from the sensors 408. The example tensile strength testing apparatus is not meant to be limiting as the same or other machines such as a universal testing machine can be used to perform other activities such as compression, flex, peel, puncture, friction, shear tests, or otherwise other tests for use in performing one or more methods described herein.

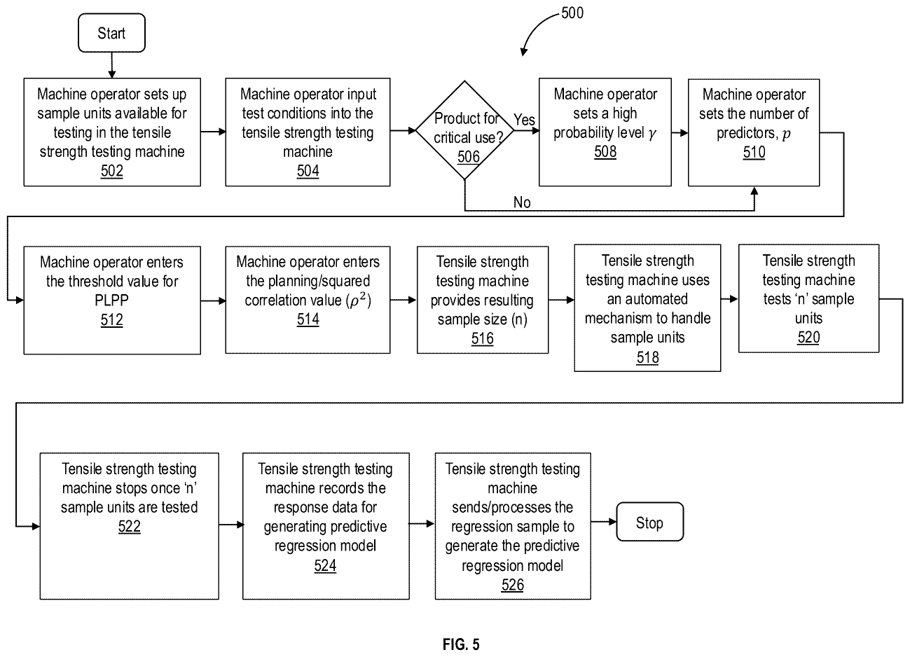

FIG. 5 illustrates a detailed flowchart 500 outlining an exemplary tensile strength evaluation process using the apparatus of FIG. 4. Initially, the operator places the sample units consisting of some products or materials into the tensile strength testing apparatus 400 at block 502 and defines test conditions such as tension or displacement testing at block 504. At block 506, the operator determines whether rigorous or less rigorous testing conditions are required based on a type or use of the sample being tested. For example, food, pharmaceutical, or medical device products may require more rigorous specifications because of the dangerous potential of defectives in the field and therefore may require more sample units to be tested to ensure the accuracy of the predictive regression model. In another example, if the sample units are other manufactured goods, such as golf clubs or board games, they may have less rigorous specifications and therefore a less demanding sample size planning method can be used.

Blocks 508 through 514 describe setting rigorous or less rigorous testing conditions, selecting an appropriate predictive accuracy criterion, and providing a squared correlation value. At block 508, if the operator determines that the sample units to be tested are critical for consumer safety, the operator sets a high probability level γ, typical values for which are from 0.8 to 0.99, indicating the probability that the PLPP does not exceed the specified threshold value, ¿. In situations, where the sample units or products to be tested do not require rigorous testing standards, the operator skips the block 508 and goes to block 510, in which the operator sets the number of predictors, p that may influence the tensile strength of the product.

At block 512, the operator provides one or more predetermined predictive accuracy criterion including a threshold value ¿, to ensure that a proportional loss in predictive precision (PLPP) (e.g., 1%, 5%, 10%, 20%) using the predictive model is within allowable limits. At block 514, the operator provides the squared correlation value (ρ²) indicative of a strength of linear relationship between the tensile strength of the sample unit and the one or more predictors or input variables. Typically, the operator receives the squared correlation value (ρ²) from at least one of: one or more expert opinions or one or more historical testing sessions where a regression model was developed to describe a linear relationship between the tensile strength and the same input variables or predictors. In situations where a single squared correlation value (ρ²) cannot be relied upon then a range of possible values for ρ², preferably a lower bound, is used. In situations where the squared correlation value (ρ²) is not available, a pilot or small study may be conducted to estimate the squared correlation value (ρ²*) to be used as a planning value in the main study or evaluation.

Once the sample size (n) needed to control the predictive performance of the regression model is established at block 516, the operator instructs the tensile strength testing apparatus 400 via the user interface 412 to initiate the testing automatically. At block 518, an automated sample unit handling mechanism of the tensile strength testing apparatus 400 sequentially places each of the sample units or products for testing. At block 520, the sample units are tested by the tensile strength testing apparatus 400 while collecting the response data and corresponding predictor data. Upon completion of testing of the sample units, the tensile strength testing apparatus 400 automatically stops at block 522.

The collected regression data is then utilized at block 524 to generate the regression model. This regression model can be generated locally by the processor 416 or remotely on a server or external computer at block 526, after which the evaluation concludes.

The disclosed methods effectively address the limitations inherent in traditional predictive model development, significantly enhancing efficiency, accuracy, and reliability. The methods can be employed in industries ranging from manufacturing to pharmaceuticals that benefit from precise predictions, optimized resource usage, reduced operational costs, and improved overall product quality and safety.

### CONCLUSION

Any specific manifestations of these and other similar example processes are not intended to be limiting to the disclosure. Any suitable manifestation of these and other similar example processes can be selected within the scope of the illustrative embodiments.

Thus, a computer-implemented method, system or apparatus, and computer program product are provided in the illustrative embodiments for determining sample size to control the predictive performance of linear regression models and other related features, functions, or operations. Where an embodiment or a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on a dedicated system or user's computer, partly on the user's computer or dedicated system as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive.

Each feature disclosed in the specification, including the claims, abstract, and drawings, can be replaced by alternative features serving the same, equivalent, or similar purpose, unless expressly stated otherwise.

1. An apparatus for sample size planning for predictive modeling, comprising:
at least one sensor;
an automated sample unit handling mechanism configured to sequentially load and unload a plurality of sample units of a product or material for evaluation;
a controller of the apparatus operatively connected to the at least one sensor and the automated sample unit handling mechanism, the controller includes a processor and a memory with one or more computer program instructions stored in the memory, which when executed by the processor, cause the controller to:
receive a squared correlation value (ρ²) indicative of a strength of a linear relationship between a quality characteristic of a product or material and one or more predictors influencing the quality characteristic, a number of predictors (ρ), and a predetermined predictive accuracy criterion set to control predictive performance of a regression model relating the quality characteristic with the one or more predictors;
determine a regression sample size (n) required to achieve the predetermined predictive accuracy criterion based on the number of predictors (ρ) in the regression model and the squared correlation value (ρ²);
collect a regression sample with the determined regression sample size (n) by sequentially applying a stimulus to each of a plurality of randomly selected sample units and measuring response data and corresponding predictor data using the at least one sensor;
automatically terminate application of the stimulus and collection of additional sample units when a number of sample units evaluated reaches the determined regression sample size (n); and
generate the regression model using regression data including the response data and corresponding predictor data collected from the apparatus
wherein the apparatus is a tensile strength testing apparatus, wherein the tensile strength testing apparatus is configured to apply mechanical stress to the sample units to measure the corresponding response data.

2. The apparatus of claim 1, wherein the controller is configured to automated evaluation of the plurality of sample units and recording the response data received from the at least one sensor.

3. The apparatus of claim 1, wherein the controller is configured to receive the squared correlation value (ρ²), the number of predictors (ρ) in the regression model and the predetermined predictive accuracy criterion through a user interface of the controller.

4. The apparatus of claim 1, wherein the squared correlation value (ρ²) is obtained from one or more expert opinions or from prior studies involving similar regression models or from a pilot study.

5. The apparatus of claim 1, wherein the controller is configured to evaluate the quality characteristic including a physical characteristic selected from tensile strength, stress resistance or compression or force capacity of the sample units.

6. The apparatus of claim 1, wherein the controller is configured to evaluate the quality characteristic including a chemical characteristic selected from chemical composition, purity or concentration of the sample units.

7. (canceled)

8. A method for sample size planning for predictive modeling using an apparatus comprising at least one sensor, an automated sample unit handling mechanism and a controller, the method comprising:
receiving, by the controller of the apparatus, a squared correlation value (ρ²), indicative of a strength of a linear relationship between a quality characteristic of a product or material and one or more predictors influencing the quality characteristic, a number of predictors (ρ) in the regression model and a predetermined predictive accuracy criterion set to control predictive performance of a regression model relating the quality characteristic with the one or more predictors;
determining, by the controller, a regression sample size (n) required to achieve the predetermined predictive accuracy criterion based on the number of predictors (ρ) in the regression model and the squared correlation value (ρ²);
collecting, by the apparatus, a regression sample with the determined regression sample size (n) by using the automated sample unit handling mechanism to sequentially load and unload each of a plurality of randomly selected sample units of the product or material for evaluation, sequentially applying a stimulus to each of the plurality of randomly selected sample units and measuring response data and corresponding predictor data using the at least one sensor;
automatically terminating application of the stimulus and collection of additional sample units when a number of sample units evaluated reaches the determined regression sample size (n); and
generating the regression model using regression data including the response data and corresponding predictor data
wherein the apparatus is a tensile strength testing apparatus, wherein the tensile strength testing apparatus is configured to apply mechanical stress to the sample units to measure the corresponding response data.

9. The method of claim 8, further comprising receiving the squared correlation value (ρ²), the number of predictors (ρ) in the regression model and the predetermined predictive accuracy criterion through a user interface of the controller.

10. The method of claim 8, wherein the squared correlation value (ρ²) is obtained from one or more expert opinions or from prior studies involving similar regression models, or from a pilot study.

11. The method of claim 8, wherein determining the sample size (n) comprises calculating the sample size (n) using the equation:
$$n = \frac{( p - 1 ) ( 1 - {ρ}^{2} ) - ε p}{ε {ρ}^{2}} + 2 p + 2 \qquad Equation A$$
where p represents the number of predictors in the regression model, ρ² represents the squared correlation value, and ε represents a predetermined threshold value for an expected proportional loss in predictive precision (PLPP).

12. The method of claim 11 wherein the determined sample size (n) ensures that the expected proportional loss in predictive precision (PLPP) induced by using an estimated regression model to make predictions does not exceed the predetermined threshold value (8).

13. The method of claim 11 wherein the calculated sample size (n) is used for applications where moderate predictive precision is sufficient.

14. The method of claim 8, wherein determining the sample size (n) comprises calculating the sample size (n) using the equation:
$$n = \frac{( 1 - {ρ}^{2 *} ) {λ}_{0}^{2}}{{ρ}^{2 *}} + p + 2$$
where λ₀ is a numerical solution of the equation:
1+T_{p-1,λ}(−\sqrt{(ρ−1)(1/ε−1)})−T_{p-1,λ}(\sqrt{(ρ−1)(1/ε−1)})=γ,
where the function T_{p-1,λ}( ) represents the cumulative distribution function (CDF) of the noncentral t-distribution with p−1 degrees of freedom and non-centrality parameter λ.

15. The method of claim 14 wherein the determined sample size (n) ensures that a proportional loss in predictive precision (PLPP) induced by using an estimated regression model does not exceed a predetermined threshold value (ε) with a predetermined high probability (γ).

16. The method of claim 14 wherein the sample size (n) calculated is used for applications requiring higher precision, including pharmaceutical products, medical devices, or safety-critical materials.

17. The method of claim 8, wherein the quality characteristic includes a physical characteristic selected from tensile strength, stress resistance or compression or force capacity of the sample units.

18. The method of claim 8, wherein the quality characteristic includes a chemical characteristic selected from chemical composition, purity or concentration of the sample units.

19. (canceled)

20. A non-transitory computer readable storage medium storing computer-readable instructions that when executed by a processor of an apparatus comprising at least one sensor and an automated sample unit handling mechanism, cause the apparatus to:
receive a squared correlation value (ρ²), indicative of a strength of a linear relationship between a quality characteristic of a product or material and one or more predictors influencing the quality characteristic, a number of predictors (ρ) in the regression model, and a predetermined predictive accuracy criterion set to control the predictive performance of a regression model relating the quality characteristic with the one or more predictors;
determine a regression sample size (n) required to achieve the predetermined predictive accuracy criterion based on the number of predictors (ρ) in the regression model and the squared correlation value;
collect a regression sample with the determined regression sample size (n) by using the automated sample unit handling mechanism to sequentially load and unload each of a plurality of randomly selected sample units of the product or material for evaluation, sequentially applying a stimulus to each of the plurality of randomly selected sample units and measuring response values and corresponding predictors data and corresponding predictor data using the at least one sensor;
automatically terminate application of the stimulus and collection of additional sample units when the number of sample units evaluated reaches the determined regression sample size (n); and
generate the regression model using regression data including the response data and corresponding predictor data
wherein the apparatus is a tensile strength testing apparatus, wherein the tensile strength testing apparatus is configured to apply mechanical stress to the sample units to measure the corresponding response data.
